(19) United States
(12) Patent Application Publication
(10) Pub. No.: US 2026/0361599 A1
(43) Pub. Date: Nov. 12, 2026

(54) INFORMATION UPDATING METHOD, APPARATUS AND DEVICE, STORAGE MEDIUM, AND PROGRAM PRODUCT

(71) Applicants: CHINA MOBILE (SUZHOU) SOFTWARE TECHNOLOGY CO., LTD., Suzhou, Jiangsu (CN); CHINA MOBILE COMMUNICATIONS GROUP CO., LTD., Beijing (CN)

(72) Inventors: Min HE, Suzhou (CN); Jianfei HU, Suzhou (CN)

(21) Appl. No.: 19/112,904

(22) PCT Filed: Sep. 19, 2023
(86) PCT No.: PCT/CN2023/119742

§ 371 Date: Mar. 18, 2025

(30) Foreign Application Priority Data
Sep. 20, 2022 (CN) 202211143092.X

(51) Int. Cl. H04L 41/0823

(52) U.S. Cl. CPC H04L 41/0823

(57) ABSTRACT

Disclosed in the present disclosure are an information updating method, apparatus and device, a storage medium, and a program product. The information updating method is applied to a target server in a server cluster, wherein reference configuration information is stored in the target server. The information updating method comprises: acquiring current configuration information of each server in the server cluster; when target configuration information different from the reference configuration information is present, acquiring first state information corresponding to a first server storing the target configuration information; and when the first state information is a normal state, updating the target configuration information by using the reference configuration information. In this way, configuration information in a normal-state server in a server cluster is updated by means of a target server in the server cluster, and the target server and the normal-state server in the server cluster belong to a same network resource, so that the communication cost is low; moreover, the update is not affected by the abnormal-state server.

### CROSS-REFERENCE TO RELATED APPLICATION

This application is based on and claims priority to Chinese Patent Application No. 202211143092.X filed on Sep. 20, 2022 and entitled “INFORMATION UPDATING METHOD, APPARATUS, DEVICE, AND COMPUTER-READABLE STORAGE MEDIUM”, the disclosure of which is hereby incorporated by reference in its entirety.

### TECHNICAL FIELD

The disclosure relates to the field of data service technology, and in particular, to an information updating method, an apparatus, a device, a storage medium, and a program product.

### BACKGROUND

In a current public cloud storage system, generally, the management domain and the storage domain are located in different network resources. The communication cost between the management domain and the storage domain is higher than the communication cost within each domain. Configuration synchronization is determined by a control server, and the control server is required to communication once with all storage servers. Such process is time-consuming and the consumed time will increase with expansion of the storage cluster, which results in a large network communication overhead.

In addition, if some servers in the storage cluster fail due to some reason and are unable to process requests from the control server, the control server cannot update the configuration on the remaining normal storage servers. Even if requests may be sent only to normal storage servers by monitoring the status of the storage server, this would increase complexity of the system and coupling degree between the two domains. In other words, it is difficult to handle a single-point fault scenario.

### SUMMARY

In view of the above, embodiments of the disclosure provide an information updating method, an apparatus, a device, a storage medium, and a program product.

The technical solution of the embodiments of the disclosure is implemented as follows.

In a first aspect, an embodiment of the disclosure provides an information updating method. The method includes the following operations.

Current configuration information of each server in a server cluster is acquired.

When target configuration information different from reference configuration information exists, first status information corresponding to a first server which stores the target configuration information is acquired.

When the first status information is a normal status, the target configuration information is updated using the reference configuration information.

In a possible implementation, a target server may further store a current correspondence table, a current normal server set and a current abnormal server set. Here, the current correspondence table includes at least an identity of each server, status information of each server, and current configuration information of each server. The method may further include the following operations.

A configuration command carrying the reference configuration information is received from a control node to obtain the reference configuration information.

The current correspondence table is parsed to obtain the current configuration information of each server.

The first status information is determined based on an identity of the first server, the current normal server set and the current abnormal server set.

In a possible implementation, the method may further include the following operations.

For each server in the server cluster, at least one heartbeat request is consecutively sent to the server according to a preset period.

When first response information for each heartbeat request is received from a second server, it is determined that second status information of the second server is the normal status. Here, at least one first response information carries current configuration information of the second server.

The current correspondence table, the current normal server set and the current abnormal server set are updated using the at least one first response information and the second status information.

In a possible implementation, the operation that the current correspondence table, the current normal server set and the current abnormal server set are updated using the at least one first response information and the second status information may include the following operations.

A current configuration file of the second server is acquired.

The current configuration file of the second server is converted using a preset conversion algorithm to obtain the current configuration information of the second server.

The current correspondence table, the current normal server set and the current abnormal server set are updated using the current configuration information of the second server and the second status information.

In a possible implementation, the method may further include the following operations.

When it is failed to receive second response information for each heartbeat request from a third server, it is determined that third status information of the third server is an abnormal status.

The current correspondence table, the current normal server set and the current abnormal server set are updated using the third status information.

In a possible implementation, the method may further include the following operations.

A configuration update command for the reference configuration information is received from the control node.

The reference configuration information is updated based on the configuration update command to obtain updated reference configuration information.

An update success result is returned to the control node.

Current configuration information of each normal server in the normal server set is updated based on the updated reference configuration information.

In a possible implementation, the current correspondence table may further include status information of services deployed on each server. After the operation that the target configuration information is updated using the reference configuration information, the method may further include the following operations.

The current correspondence table is updated based on updated target configuration information.

Fourth status information of each service in the first server is acquired.

When target fourth status information being the abnormal status exists among the fourth status information, a target service corresponding to the target fourth status information is determined.

The target service is restarted to update the target fourth status information to the normal status.

The current correspondence table is updated based on updated target fourth status information.

In a second aspect, an embodiment of the disclosure provides an information updating apparatus. The information updating apparatus includes a first acquisition module, a second acquisition module and a first updating module.

The first acquisition module is configured to acquire current configuration information of each server in a server cluster.

The second acquisition module is configured to acquire, when target configuration information different from reference configuration information exists, first status information corresponding to a first server which stores the target configuration information.

The first updating module is configured to update, when the first status information is a normal status, the target configuration information by using the reference configuration information.

In a third aspect, an embodiment of the disclosure provides an information updating device including a processor and a memory.

The memory is configured to store a computer program executable on the processor.

Here, the computer program, when executed by the processor, implements the above information updating method.

In a fourth aspect, an embodiment of the disclosure provides a computer-readable storage medium having stored thereon computer-executable instructions configured to execute the above information updating method.

In a fifth aspect, an embodiment of the disclosure provides a computer program product including computer-readable codes. When the computer-readable codes are run in an electronic device, a processor in the electronic device performs the above information updating method.

The embodiments of the disclosure provide an information updating method, an apparatus, a device, and a computer-readable storage medium. The information updating method is applied to a target server in a server cluster. Here, the target server stores reference configuration information. The information updating method includes the following operations. The target server acquires current configuration information of each server in the server cluster. Then, each current configuration information is compared with the reference configuration information. If target configuration information different from the reference configuration information exists among the current configuration information, first status information corresponding to a first server which stores the target configuration information is acquired. Then, if the first status information corresponding to the first server is a normal status, the target configuration information is updated using the reference configuration information to complete the configuration information update. In this way, since the target server is included in the server cluster, the target server and each server in the server cluster belong to the same network resource. Therefore, when the target server communicates with each server, the network communication overhead is low. In addition, since the target server updates the configuration information for the server in the normal status, even if a server in the server cluster fails due to some reason, the configuration information update of normal servers will not be affected.

### BRIEF DESCRIPTION OF THE DRAWINGS

In the drawings (which are not necessarily drawn to scale), similar reference numerals may describe similar components in different views. The drawings generally illustrate each embodiment discussed herein in an exemplary and non-limiting manner.

FIG. 1 is a schematic diagram of a block diagram of configuration file updating in the related art.

FIG. 2 is a schematic flowchart of a configuration file updating method in the related art.

FIG. 3 is a schematic flowchart of an implementation of an information updating method provided by an embodiment of the disclosure.

FIG. 4 is a schematic flowchart of another implementation of an information updating method provided by an embodiment of the disclosure.

FIG. 5 is a schematic flowchart of an implementation of updating a current correspondence table, a current normal server set and a current abnormal server set provided by an embodiment of the disclosure.

FIG. 6 is a schematic flowchart of yet another implementation of an information updating method provided by an embodiment of the disclosure.

FIG. 7 is a schematic flowchart of yet another implementation of an information updating method provided by an embodiment of the disclosure.

FIG. 8 is a schematic flowchart of an implementation of a directional updating method provided by an embodiment of the disclosure.

FIG. 9 is a schematic flowchart of an implementation of a block diagram of configuration file updating provided by an embodiment of the disclosure.

FIG. 10 is a schematic flowchart of an implementation of a configuration file updating method provided by an embodiment of the disclosure.

FIG. 11 is a schematic flowchart of another implementation of a block diagram of configuration file updating provided by an embodiment of the disclosure.

FIG. 12 is a schematic diagram of a structure of an information updating apparatus provided by an embodiment of the disclosure.

FIG. 13 is a schematic diagram of a structure of an information updating device provided by an embodiment of the disclosure.

### DETAILED DESCRIPTION

To make the purposes, technical solutions, and advantages of the disclosure clearer, in the following, the disclosure will be described in detail in combination with the drawings. The described embodiments should not be regarded as limitation on the disclosure. Any other embodiments obtained by those of ordinary skill in the art without making inventive labor fall within the scope of protection of the disclosure.

In the following description, the term “some embodiments” describes a subset of all possible embodiments. However, it is to be understood that “some embodiments” may be the same subset or different subsets of all possible embodiments, and may be combined with each other without conflict.

In the following description, the terms “first/second/third” are used only to distinguish similar objects and do not represent a specific order of objects. It is to be understood that “first/second/third” may be interchanged in a specific order or sequence if permitted, such that the embodiments of the disclosure described herein may be implemented in an order other than that illustrated or described herein.

Unless otherwise defined, all technical and scientific terms used herein have the same meanings as commonly understood by those skilled in the art to which the disclosure belongs. Terms used herein are only for the purpose of describing the embodiments of the disclosure, and are not intended to limit the disclosure.

To better understand the information updating method provided by the embodiments of the disclosure, firstly, the configuration method for distributed storage clusters on the public cloud in the related art, and existing disadvantages thereof, are illustrated.

A public cloud storage service refers to a service in which the physical resource pool is constructed and managed by a third party, and a user is allowed to apply for a portion as a private space through a graphical interface to store various types of data. Distributed means that different services are deployed on different servers, and a cluster refers to a system in which some servers are grouped together, achieve inter-process communication through a network, so as to complete the same task outwards.

Generally, a cluster has several cluster-related configuration items, such as a cluster name, a cluster Identity Document (ID), a cluster composition, and an exposed storage space division of the cluster. These cluster configurations need to exist on each server and must be identical. Only in this way, it may be ensured that these servers may stably form a cluster and provide consistent services outwards. Configuration information of the cluster is generally stored in files, and these files are stored at the same path on each server in the cluster and have identical contents. When a service on a server starts or after a configuration file is updated, the service needs to load the relevant configuration information into the memory. Information of the storage cluster is not static, for example, the composition information of the cluster will change with expansion, and the storage space division within the cluster will change in real time with user ordering. Therefore, how to dynamically determine consistency of configuration files on the servers is particularly important.

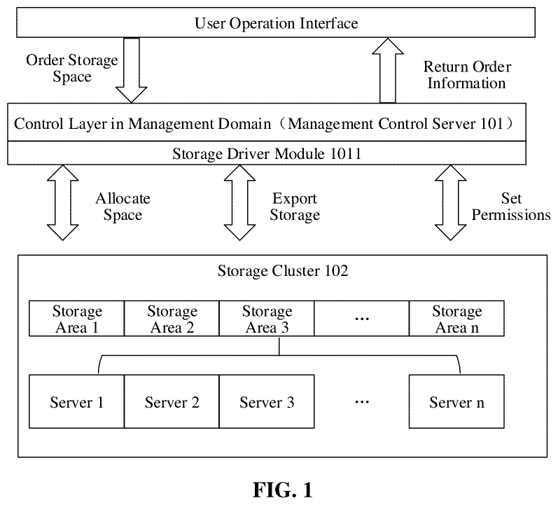

As shown in FIG. 1, in a public cloud system, a user request (such as storage space activation, authorization, or the like) is firstly issued to a management control server 101. A storage driver module 1011 of the control server 101 parses the user request, breaks the user request down into smaller requests, and issues them to a storage cluster 102 to complete. Here, operations such as storage space activation, storage space expansion, or the like, will lead to changes in configuration information of each node in the storage cluster.

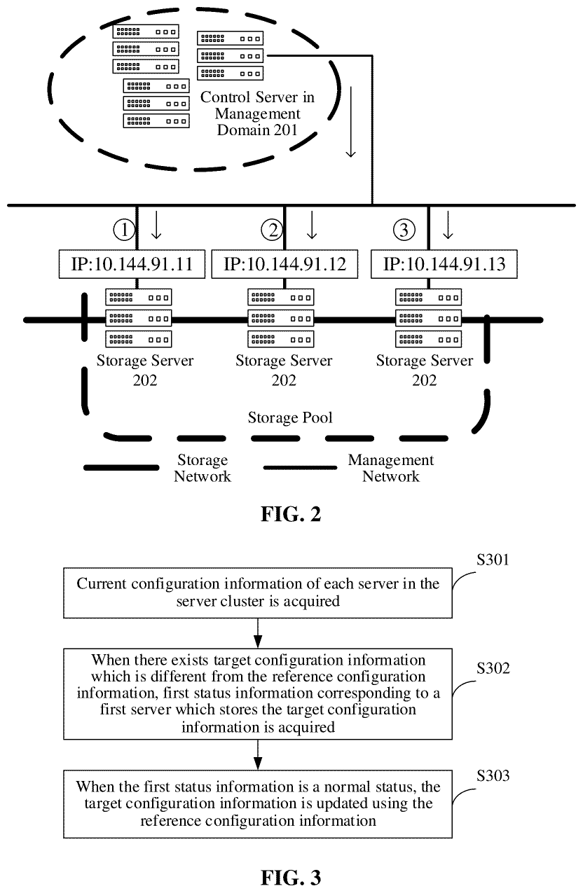

In the related art, the consistency of configuration files is determined by the control server in the management domain. As shown in FIG. 2, a control server 201 issues a configuration update request to all storage servers 202 in the cluster. After responses that the configuration has been successfully updated in the memory are received from all the storage servers 202, the request is considered successful. Otherwise, the request is considered to be failed, and it is necessary to roll a part of storage servers that have successfully updated the configuration back to the status before the configuration is updated.

Therefore, there are problems of significant network communication overhead and difficulty in handling a single-point fault scenario in the related art.

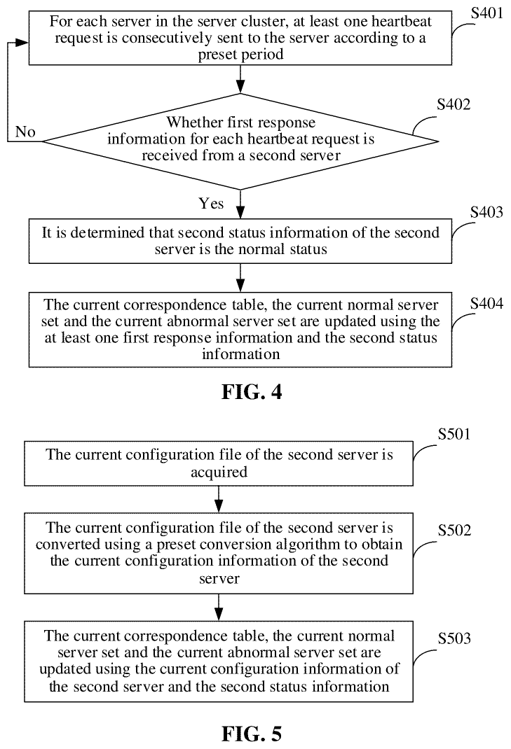

Based on the problems in the related art, an embodiment of the disclosure provides an information updating method. The method provided by the embodiment of the disclosure may be implemented by a computer program that, when executed, completes the information updating method provided by the embodiment of the disclosure. In some embodiments, the computer program may be executed by a processor in an information updating device. FIG. 3 is a flowchart of an implementation of the information updating method provided by the embodiment of the disclosure, and the information updating method is applied to a target server in a server cluster. Here, the target server stores reference configuration information. As shown in FIG. 3, the information updating method includes the following operations.

In operation S301, current configuration information of each server in the server cluster is acquired.

Here, each server in the server cluster is located in the same network resource, and there is communication connection between any two servers. Based on this, information transmission may be performed between any two servers.

In the embodiments of the disclosure, the target server may acquire the current configuration information of each server in the server cluster in real time or periodically. Here, the current configuration information also includes the current configuration file of the target server.

Exemplarily, if the server cluster includes 10 servers, the target server acquires the current configuration information of the 10 servers.

In operation S302, when there exists target configuration information which is different from the reference configuration information, first status information corresponding to a first server which stores the target configuration information is acquired.

Here, the target server compares each piece of current configuration information with the reference configuration information to determine whether the current configuration information is consistent with the reference configuration information. If the target configuration information different from the reference configuration information exists among the current configuration information, the target server further acquires the first status information corresponding to the first server which stores the target configuration information. Here, the first status information is used to indicate the status of the first server.

Exemplarily, the first status information may be a normal status or an abnormal status. Here, the normal status indicates that the first server is operating normally, and the abnormal status indicates that the first server cannot operate.

In some embodiments, if no target configuration information different from the reference configuration information exists among the current configuration information, it indicates that the current configuration information of each server is consistent with the reference configuration information, and no configuration information update operation is needed. The process may return to the operation S301 or terminate.

In operation S303, when the first status information is a normal status, the target configuration information is updated using the reference configuration information.

Here, it is firstly determined whether the first status information is the normal status. If it is determined that the first status information is the normal status, it indicates that the first server may operate normally. Based on this, the target configuration information may be updated using the reference configuration information, such that the updated target configuration information is consistent with the reference configuration information, and thereby update of the target configuration information is completed.

In some embodiments, if it is determined that the first status information is the abnormal status, it indicates that the first server cannot operate. The first server is an abnormal server, or the first server may be considered as a server that fails due to some reason, and thus the first server cannot interact normally with the target server or the upper-level control node. In such case, an alarm message carrying the identity of the first server may be output to prompt timely maintenance of the first server, and the target configuration information of the first server will not be updated.

The embodiments of the disclosure provide an information updating method. The information updating method is applied to a target server in a server cluster. Here, the target server stores reference configuration information. The information updating method includes the following operations. The target server acquires current configuration information of each server in the server cluster. Then, each current configuration information is compared with the reference configuration information. If target configuration information different from the reference configuration information exists among the current configuration information, first status information corresponding to a first server which stores the target configuration information is acquired. Then, if the first status information corresponding to the first server is a normal status, the target configuration information is updated using the reference configuration information to complete the configuration information update. In this way, since the target server is included in the server cluster, the target server and each server in the server cluster belong to the same network resource. Therefore, when the target server communicates with each server, the network communication overhead is low. In addition, since the target server updates the configuration information for the server in the normal status, even if a server in the server cluster fails due to some reason, the configuration information update of normal servers will not be affected.

In some embodiments, before the above operation S301 that the current configuration information of each server in the server cluster is acquired is performed, firstly, the target server needs to acquire the reference configuration information. Based on this, the reference configuration information may be obtained in the following manner.

A configuration command carrying the reference configuration information is received from a control node to obtain the reference configuration information.

In a practical implementation, the control node may send the configuration command to the target server in real time or periodically, such that the target server obtains the reference configuration information. Since the reference configuration information is relative and may change over time, it is ensured that the target server may obtain the accurate reference configuration information by receiving the configuration command in real time or periodically. Here, the control node refers to a node that is located at a higher level of the server cluster and sends control commands to the server cluster. Exemplarily, if the server cluster is a storage server cluster, the control node may be a control server.

In some embodiments, the target server further stores a current correspondence table, a current normal server set and a current abnormal server set. Here, the current correspondence table includes at least an identity of each server, status information of each server, and current configuration information of each server.

Based on this, the above operation S301 that the current configuration information of each server in the server cluster is acquired may be implemented in the following manner.

The current correspondence table is parsed to obtain the current configuration information of each server. That is, the target server parses the current correspondence table and obtains the current configuration information of each server from the parsing result.

The above operation S302 that the first status information corresponding to the first server which stores the target configuration information is acquired may be implemented in the following manner.

Firstly, an identity of the first server is acquired. Then, the first status information is determined based on the identity of the first server, the current normal server set and the current abnormal server set. Here, the current normal server set stores identities of normal servers, and the current abnormal server set stores identities of abnormal servers.

In the embodiments of the disclosure, the identity of the first server may be compared with the identities of normal servers. If the identity of the first server is included in the identities of normal servers, it indicates that the first server is a normal server, that is, the first status is the normal status. Alternatively, the identity of the first server may be compared with the identities of abnormal servers. If the identity of the first server is included in the identities of abnormal servers, it indicates that the first server is an abnormal server, that is, the first status is the abnormal status.

In some embodiments, the current correspondence table, the current normal server set and the current abnormal server set may be timely updated by heartbeat detection. Based on this, before the above operation S301 that the current configuration information of each server in the server cluster is acquired is performed, as shown in FIG. 4, the information updating method further includes the following operations S401 to S404.

In operation S401, at least one heartbeat request is consecutively sent to each server in the server cluster according to a preset period.

Here, the preset period may be a default value or a custom value. Exemplarily, the preset period may be 8 seconds, 9 seconds, 10 seconds, 11 seconds, etc.

In the embodiments of the disclosure, the number of the at least one heartbeat request may be 1, 2, 3, etc. Generally, in order to improve accuracy and reliability of the result, the number of the at least one heartbeat request is multiple. Exemplarily, the number of the at least one heartbeat request may range from 2 to 10.

In some embodiments, if a server may respond to the heartbeat request normally, the preset period may remain unchanged. If a server cannot respond to the heartbeat request normally, the preset period may be reduced according to a linear algorithm or an exponential algorithm, that is, heartbeat requests are sent to the server more frequently, so as to timely determine whether the server is abnormal.

In a practical implementation, in order to ensure normal operation of the server cluster, the preset period will not continually reduced. The preset period has a minimum period threshold. When the preset period is reduced to the minimum period threshold, the preset period is no longer reduced. Exemplarily, the minimum period threshold may be 1 second, 2 seconds, 3 seconds, etc.

In operation S402, it is determined whether first response information for each heartbeat request is received from a second server.

Here, it is assumed that the number of the at least one heartbeat request is 3. If the target server receives three first response information returned by the second server, it is determined that the first response information for each heartbeat request is received from the second server, and the process proceeds to operation S403. If the target server does not receive three first response information returned by the second server, the process returns to the operation S401.

In the embodiments of the disclosure, at least one first response information carries a current configuration file of the second server.

In operation S403, it is determined that second status information of the second server is the normal status.

Here, it is still assumed that the number of the at least one heartbeat request is 3. When the target server receives three first response information returned by the second server, it is determined that the second status information of the second server is the normal status.

In operation S404, the current correspondence table, the current normal server set and the current abnormal server set are updated using the at least one first response information and the second status information.

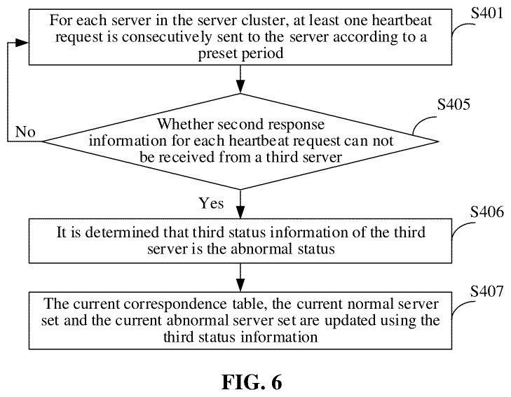

In a practical implementation, as shown in FIG. 5, the operation S404 may be implemented by the following operations S501 to S503.

In operation S501, the current configuration file of the second server is acquired.

Here, the current configuration file of the second server may be extracted from the at least one response information by information extraction.

In operation S502, the current configuration file of the second server is converted using a preset conversion algorithm to obtain the current configuration information of the second server.

Here, the configuration file may be a file including text information, and the current configuration information may be information including numerical values. The current configuration file may be converted into the current configuration information by the preset conversion algorithm. In this way, comparison between current configuration files may be implemented by comparison between different current configuration information, so as to obtain similarities and differences between two configuration files accurately and rapidly. Exemplarily, the preset conversion algorithm may be the Message Digest Algorithm (MD5).

In operation S503, the current correspondence table, the current normal server set and the current abnormal server set are updated using the current configuration information of the second server and the second status information.

Here, firstly, the configuration information of the second server in the current correspondence table is replaced with the current configuration information of the second server. Then, it is determined whether the status information of the second server in the current correspondence table is consistent with the second status information. If not, the status information of the second server in the current correspondence table is replaced with the second status information. In this way, update of the current correspondence table is completed.

In the embodiments of the disclosure, if it has been determined that the second status information is the normal status, it is determined whether the current normal server set includes the identity of the second server. If the normal server set does not include the identity of the second server, the identity of the second server is added to the normal server set. In addition, it is also determined whether the current abnormal server set includes the identity of the second server. If the abnormal server set includes the identity of the second server, the identity of the second server is removed from the abnormal server set. In this way, update of the current normal server set and the current abnormal server set is completed.

In some embodiments, if the status information of the second server in the current correspondence table is consistent with the second status information, there is no need to replace the status information of the second server in the current correspondence table with the second status information, and the status information of the second server in the current correspondence table remains unchanged. If the normal server set includes the identity of the second server, the normal server set may remain unchanged. If the abnormal server set does not include the identity of the second server, the abnormal server set may remain unchanged.

In the embodiments of the disclosure, by the above operations S401 to S404, the status of the server may be detected by the heartbeat request. When multiple heartbeat results indicate that the second server is normal, it is determined that the second server is in the normal status, thereby improving the accuracy and reliability. In addition, the current correspondence table, the normal server set and the abnormal server set may be updated based on the status of the second server and the first response information, thereby ensuring that the current correspondence table, the normal server set and the abnormal server set are updated in real time.

In some embodiments, after the above operation S401 that the at least one heartbeat request is consecutively sent to each server in the server cluster according to the preset period, there may be a case in which the target server does not receive the response information corresponding to each heartbeat request. Based on this, after the above operation S401, as shown in FIG. 6, the following operations S405 to S407 may further be performed.

In operation S405, it is determined whether second response information for each heartbeat request cannot be received from a third server.

Here, it is still assumed that the number of the at least one heartbeat request is 3. If the target server does not receive the second response information for any heartbeat request from the third server, that is, the target server cannot receive the second response information for each heartbeat request from the third server, it indicates that the target server does not receive the second response information returned by the third server, and the process proceeds to operation S406. Otherwise, the process returns to the operation S401.

In operation S406, it is determined that third status information of the third server is the abnormal status.

Here, it is still assumed that the number of the at least one heartbeat request is 3. When the target server receives 0 second response information returned by the third server, it is determined that the third status information of the third server is the abnormal status.

In operation S407, the current correspondence table, the current normal server set and the current abnormal server set are updated using the third status information.

Here, it is determined whether the status information of the third server in the current correspondence table is consistent with the third status information. If not, the status information of the third server in the current correspondence table is replaced with the third status information. In this way, update of the current correspondence table is completed.

In the embodiments of the disclosure, if it has been determined that the third status information is the abnormal status, it is determined whether the current normal server set includes the identity of the third server. If the normal server set includes the identity of the third server, the identity of the third server is removed from the normal server set. In addition, it is also determined whether the current abnormal server set includes the identity of the third server. If the abnormal server set does not include the identity of the third server, the identity of the third server is added to the abnormal server set. In this way, update of the current normal server set and the current abnormal server set is completed.

In some embodiments, if the status information of the third server in the current correspondence table is consistent with the third status information, there is no need to replace the status information of the third server in the current correspondence table with the third status information, and the status information of the third server in the current correspondence table remains unchanged. If the normal server set does not include the identity of the third server, the normal server set may remain unchanged. If the abnormal server set includes the identity of the third server, the abnormal server set may remain unchanged.

By the above operations S401 to S407 in FIG. 6, the status of the server may be detected by the heartbeat request. When multiple heartbeat results indicate that the third server is abnormal, it is determined that the third server is in the abnormal status, thereby improving the accuracy and reliability. In addition, the current correspondence table, the normal server set and the abnormal server set may be updated based on the status of the third server, thereby ensuring that the current correspondence table, the normal server set and the abnormal server set are updated in real time.

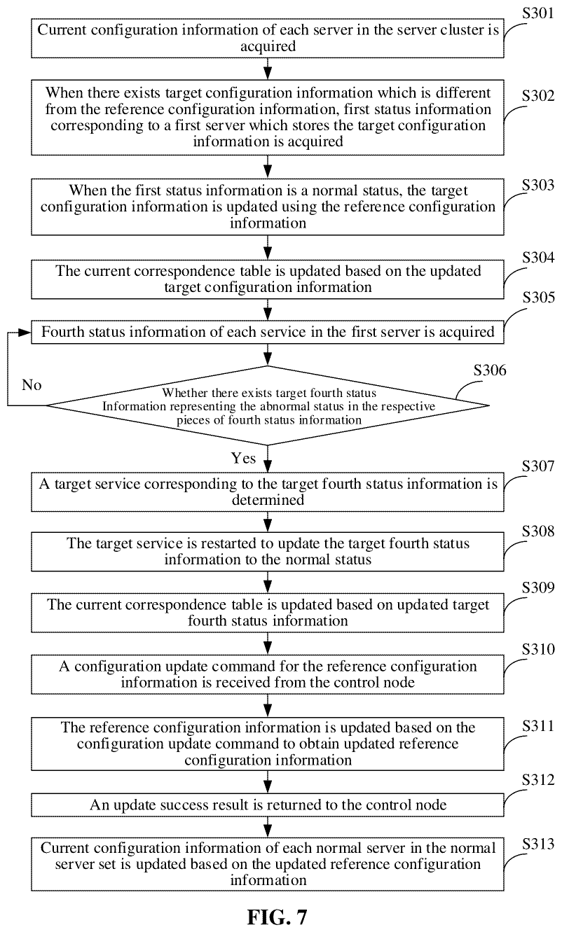

In some embodiments, the current correspondence table further includes status information of services deployed on each server. After the above operation S303 that when the first status information is the normal status, the target configuration information is updated using the reference configuration information, as shown in FIG. 7, the following operations S304 to S313 may further be performed.

In operation S304, the current correspondence table is updated based on the updated target configuration information.

Here, since the updated target configuration information changes, the current configuration information of the first server in the current correspondence table is replaced with the updated configuration information, and thereby update of the current correspondence table is implemented.

In operation S305, fourth status information of each service in the first server is acquired.

Here, the fourth status information of each service in the first server may be obtained through a read command.

In operation S306, it is determined whether target fourth status information being the abnormal status exists among the fourth status information.

Here, different status information of a service may be represented by different codes. Exemplarily, abnormal status information of a service may be represented by “001”, and normal status information of a service may be represented by “002”. Based on this, if it is determined that a target fourth status with the code “001” exists among the fourth status information, the process proceeds to operation S307. If it is determined that a non-target fourth status with the code “002” exists among the fourth status information, the process returns to the operation S305.

In operation S307, a target service corresponding to the target fourth status information is determined.

Here, the target service corresponding to the abnormal status is determined.

In operation S308, the target service is restarted to update the target fourth status information to the normal status.

Here, the target service may be restarted through a startup command. Update of the target configuration information of the first server, on which the target service is deployed, has been completed. Based on this, the target service may be restarted to enable the target service to operate normally, such that the fourth status information corresponding to the target service is updated from the abnormal status to the normal status.

In operation S309, the current correspondence table is updated based on updated target fourth status information.

Here, the updated fourth status information is the normal status. Therefore, the status information of the target service in the current correspondence table is replaced with the updated fourth status information, and thereby update of the current correspondence table is completed.

In operation S310, a configuration update command for the reference configuration information is received from the control node.

Here, the target server may further receive the configuration update command from the control node. Here, the configuration update command is used to indicate to update the current configuration information of each server in the server cluster.

In operation S311, the reference configuration information is updated based on the configuration update command to obtain updated reference configuration information.

Here, the configuration update command carries the updated reference configuration information, and updated configuration parameters may be obtained by parsing the configuration update command.

In operation S312, an update success result is returned to the control node.

Here, after obtaining the updated configuration information, the target server generates the update success result and returns it to the control node.

In operation S313, current configuration information of each normal server in the normal server set is updated based on the updated reference configuration information.

Here, the update process in the operation S313 is similar to the update process in the above operation S303 that the target configuration information is updated using the reference configuration information. Therefore, the update process in the operation S313 may be referred to the update process in the above operation S303 that the target configuration information is updated using the reference configuration information.

In some embodiments, for an abnormal server, no configuration update is performed. An alarm message carrying the identity of the abnormal server may be output to prompt timely.

In the embodiments of the disclosure, by the above operations S304 to S313, the current correspondence table may further be updated based on the updated target configuration information. Then, the target service in the abnormal status may further be determined based on the status information of each service deployed on the first server. The target service is then restarted to update the target fourth status information corresponding to the target service from the abnormal status to the normal status. Subsequently, the current correspondence table is updated based on the updated target fourth status information, so as to determine correctness and real-time nature of the current correspondence table. In addition, the target server may further receive the configuration update command from the control node, and obtain the updated reference configuration information based on the configuration update command. Then, the configuration information of each normal server in the server cluster is updated based on the updated reference configuration information, so as to achieve rapid and efficient update of the configuration information.

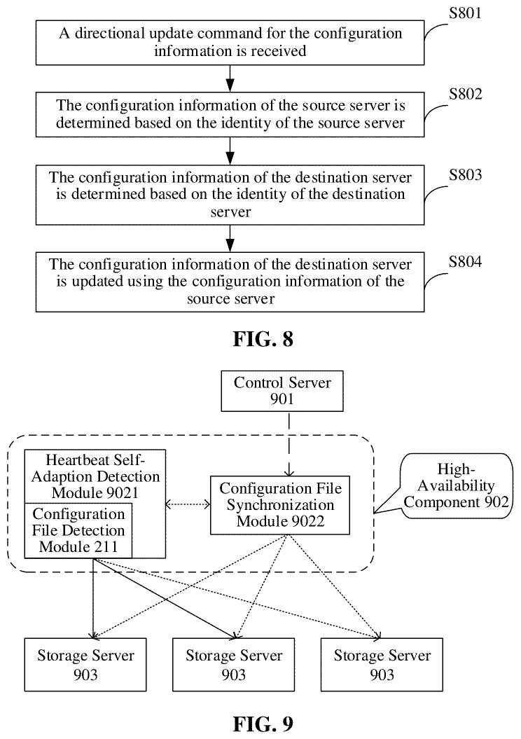

In some embodiments, the target server may further perform directional update of the configuration information based on a directional update command. As shown in FIG. 8, the information updating method may further include the following operations S801 to S804.

In operation S801, a directional update command for the configuration information is received.

Here, the directional update command refers to updating configuration information of a destination server to configuration information of a source server. The directional update command carries an identity of the source server and an identity of the destination server.

In the embodiments of the disclosure, the directional update command may be from the control node, or the directional update command may be from outside the control node, that is, the outside inputs the directional update command to the target server.

In operation S802, the configuration information of the source server is determined based on the identity of the source server.

Here, the configuration information of the source server is determined from the current correspondence table using the identity of the source server.

In operation S803, the configuration information of the destination server is determined based on the identity of the destination server.

Here, the implementation process of the operation S803 is similar to that of the above operation S802. Therefore, the implementation process of the operation S803 may be referred to the implementation process of the above operation S802.

In operation S804, the configuration information of the destination server is updated using the configuration information of the source server.

Here, the configuration information of the destination server is replaced with the configuration information of the source server to complete update of the destination server. That is, the configuration information of the source server is copied to a location on the destination server where the configuration information is stored.

In the embodiments of the disclosure, the identity of the source server and the identity of the destination server are obtained based on the received directional update command. Then, the configuration information of the source server is determined based on the identity of the source server, and the configuration information of the destination server is determined based on the identity of the destination server. Subsequently, the configuration information of the destination server is updated using the configuration information of the source server, and thereby the directional update is completed.

In the embodiments of the disclosure, the target servers are multiple servers in the server cluster. In a practical implementation, in order to determine redundancy, the number of target servers is generally not less than three. These target servers may also form a small cluster. The target server cluster is in an active-standby mode, and multiple target servers provide a unified virtual Internet Protocol (IP) outwards for communication. If the current active target server fails, the virtual IP drifts to a standby target server that does not fail to continue updating the configuration file. In this way, the storage intranet is fully used, which enables operations faster and allows single-point or even multi-point faults, and the control node is unaware of the fault.

Based on the above embodiments, an embodiment of the disclosure further provides an information updating method applied to a distributed storage cluster on a public cloud, which may also be referred to as an improved configuration management method for a distributed storage cluster on a public cloud. The embodiment of the disclosure introduces a new high-availability lightweight component to the storage cluster, and the composition of the component is as shown in FIG. 9. A distributed system includes a control server 901, a high-availability component 902 and multiple storage servers 903. The high-availability component 902 further includes a heartbeat self-adaption detection module 9021 and a configuration file synchronization module 9022. The heartbeat self-adaption detection module 9021 includes a configuration file detection module 211. Here, the control server corresponds to the control node in the above embodiments. The multiple storage servers form a storage server cluster, which corresponds to the server cluster in the above embodiments. The high-availability component may be deployed on a part of storage servers, and the storage server on which the high-availability component is deployed corresponds to the target server in the above embodiments.

Functions of the heartbeat self-adaption detection module 9021 include sending heartbeat requests to all storage servers, and collecting statuses of servers, statuses of services, and MD5 values of configuration files in the storage server cluster. The heartbeat self-adaption detection module 9021 has two main characteristics, i.e., self-adaption detection and configuration file detection. The self-adaption characteristic may further be divided into two aspects, i.e., self-adaption of the detection period, and self-adaption of the reliability. The self-adaption of the detection period means that when detecting that a server is abnormal, the heartbeat module reduces the heartbeat detection interval until the interval is reduced to a set minimum limit. Here, the interval corresponds to the preset period in the above embodiments. The embodiment of the disclosure provides two algorithms for reducing the interval, i.e., a linear algorithm and an exponential algorithm, and correspondingly provides four parameters that may be set according to actual business situations.

Parameter 1: interval_descent_algorithm, used to specify the descent algorithm. Two algorithms are provided in the related art, and thus the value may be 1 or 2. 1 represents the linear algorithm and 2 represents the exponential algorithm.

Parameter 2: default_heartbeat_interval, used to denote the period of the heartbeat detection in the normal situation, with a unit of millisecond (ms) and a default value of 10,000 ms.

Parameter 3: attenuation_coefficient, used to denote the attenuation coefficient, i.e., the proportion by which the interval is reduced when an abnormal server is detected. The default value for the linear algorithm is 0.85, and the default value for the exponential algorithm is the natural exponential e (approximately 2.718282). The linear algorithm of the heartbeat interval is: interval=default_heartbeat_interval−attenuation_coefficient×time. The exponential algorithm of the heartbeat interval is: interval=default_heartbeat_interval×(1−attenuation_coefficient^{(-1/time)}), where time denotes the number of failed interactions with the storage server.

Parameter 4: minimum_heartbeat_interval, used to denote the minimum period of the heartbeat detection, with a unit of millisecond (ms) and a default value of 2,000 ms.

Based on this, the final value of the heartbeat interval may be divided into the following two cases.

In case 1, when the number of heartbeat faults is 0, the heartbeat interval may be the period of the heartbeat detection in the normal situation. That is, the value of the heartbeat interval is default_heartbeat_interval.

In case 2, when the number of heartbeat faults is greater than 0, the heartbeat interval may be the larger value between the minimum period of the heartbeat detection and the attenuated heartbeat interval. That is, the value of the heartbeat interval is max{minimum_heartbeat_interval, interval}.

The self-adaption of the reliability means that whether a server changes from normal to faulty or from faulty to normal, it is not determined by a single heartbeat result but by a cumulative result of multiple heartbeats, which increases reliability of the determination result. The embodiment of the disclosure provides the following two parameters.

down_reliability, with a default value of 3. If the heartbeat from server A to server B fails three times consecutively, or if the service status in the result returned by the heartbeat is abnormal, it is considered that server B is unable to provide services. The advantage of such approach is that a heartbeat fault may be caused by network or service jitter, and an occasional heartbeat fault is insufficient to prove that the server fails. Only when the cumulative number of consecutive faults reaches a reliability threshold, it is considered that the server fails, which increases the reliability.

up reliability, with a default value of 3. It is assumed that server B originally fails. After server B recovers, server A will consider that server B has returned to normal only after server A has three consecutive successful heartbeats with server B.

In the embodiments of the disclosure, the heartbeat self-adaption detection module maintains a table and two sets in the memory. Here, the key in the table is the address of the server in the cluster, and the value is the status information of the corresponding server. The table corresponds to the current correspondence table in the above embodiments, and the form of the table is as shown in Table 1.

TABLE 1
Overview of Storage Server Information

| Server Address | Server Status Information |
|---|---|
| 10.144.91.11 | {“server_status”: “alive”, “service_status”: “active”, |
| | “conf_md5”: “e765699bd75517e366888e4b4b034724”} |
| 10.144.91.12 | {“server_status”: “alive”, “service_status”: “inactive”, |
| | “conf_md5”: “e765699bd75517e366888e4b4b034724”} |
| 10.144.91.13 | {“server_status”: “lost”, “service_status”: “active”, |
| | “conf_md5”: “5c9597f3c8245907ea71a89d9d39d08e”} |

In Table 1, server_status denotes the status of the server, where “alive” means that the server may receive heartbeat requests from the high-availability component normally, and “lost” means that the server cannot receive requests or respond to heartbeat requests, such as a case of server fault. service_status denotes the status of the relevant service on the server, where “active” means that the service is operating outwards normally, and “inactive” means that the service is not started or the service is started but cannot operate normally, such as a case in which the status of the service is abnormal due to lag of configuration file. conf_md5 denotes the MD5 value of the configuration file.

In the embodiments of the disclosure, the two sets are normal_list and abnormal_list. Here, normal_list stores the address information of all normal servers, and corresponds to the normal server set in the above embodiments. abnormal_list stores the address information of all abnormal servers, and corresponds to the abnormal server set in the above embodiments. The table and the two sets are updated after each heartbeat is completed.

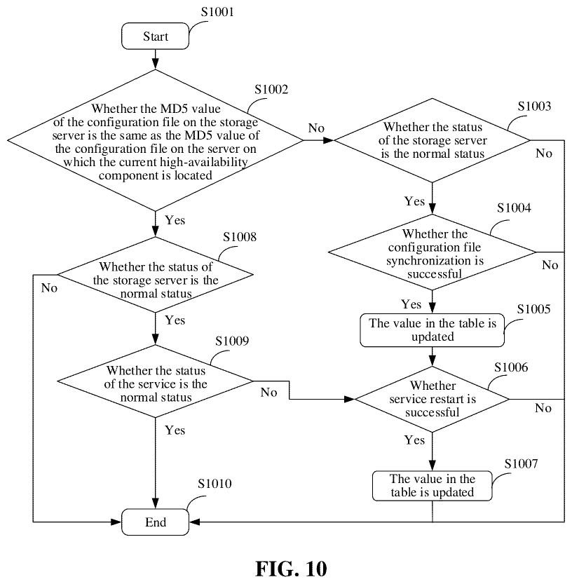

The configuration file detection module in the heartbeat self-adaption detection module assesses the collected information of each server after each heartbeat, and performs a corresponding repair process. The process is shown in FIG. 10 and includes operations S1001 to S1010.

In operation S1001, the process is started.

In operation S1002, it is determined whether the MD5 value of the configuration file on the storage server is the same as the MD5 value of the configuration file on the server on which the current high-availability component is located.

Here, if the MD5 value of the configuration file on the storage server is not the same as the MD5 value of the configuration file on the server on which the current high-availability component is located, it is considered that the configuration file on the storage server is not the latest, and the status of the server is checked, that is, the process proceeds to operation S1003. If the MD5 value of the configuration file on the storage server is the same as the MD5 value of the configuration file on the server on which the current high-availability component is located, it is considered that the configuration file on the storage server is the latest, and the status of the server and the status of the service are checked, that is, the process proceeds to operation S1008.

In operation S1003, it is determined whether the status of the storage server is the normal status.

Here, if the storage server is in the normal status, an attempt is made to perform configuration file synchronization, that is, the process proceeds to operation S1004. If the storage server is in the abnormal status, the process proceeds to operation S1010.

In operation S1004, it is determined whether the configuration file synchronization is successful.

Here, if the configuration file synchronization is successful, the process proceeds to operation S1005. If the configuration file synchronization fails, the process proceeds to operation S1010.

In operation S1005, the value in the table is updated.

Here, if the configuration file synchronization is successful, the MD5 value of the configuration file in the table is updated. The service is also restarted to load the latest configuration.

In operation S1006, it is determined whether service restart is successful.

Here, if the service restart is successful, the table is updated, that is, the process proceeds to operation S1007. If the service restart fails, the process proceeds to operation S1010.

In operation S1007, the value in the table is updated.

Here, if the service restart is successful and the status of the service is updated to the normal status, it is necessary to update the status of the service in the table using the normal status of the service.

In operation S1008, it is determined whether the status of the storage server is the normal status.

Here, if the status of the storage server is the normal status, the process proceeds to operation S1009. If the status of the storage server is the abnormal status, the process proceeds to operation S1010.

In operation S1009, it is determined whether the status of the service is the normal status.

Here, if the status of the service is the normal status, the process proceeds to operation S1010. If the status of the service is the abnormal status, an attempt is made to trigger the server to restart the service, that is, the process returns to the operation S1006.

In the embodiments of the disclosure, the configuration file synchronization module's job is to synchronize the latest configuration information on the current storage server to other servers. It has three working modes. In the first working mode, the modification operation issued by the control server this time is synchronized. In the second working mode, the entire configuration file is synchronized. In the third working mode, the configuration file is directionally synchronized.

Here, the first working mode is triggered by the control node. The control node sends a request to the high-availability component. After receiving the request, the high-availability component modifies the local configuration file. When the modification is successful, it returns to the control node and synchronizes the request from the control node this time to the servers in the normal_list. If the synchronization is successful, no further process is performed. If the synchronization fails after a designated number of retries, the failed server is moved from the normal_list to the abnormal_list.

The second working mode is triggered by the configuration file detection module of the heartbeat module. As can be known in the above introduction of the heartbeat module, the detection module may also trigger configuration synchronization when specific conditions are satisfied. Such type of synchronization is synchronization of the entire configuration file.

The third working mode may be triggered by human intervention, which may achieve copying a configuration file on a designated source server to a designated location on a designated destination server. The source server, the destination server and the high-availability component do not need to be in the same cluster, as long as the network is connected. Such mode is often used for internal test of the storage cluster.

In some embodiments, in order to facilitate operation and maintenance management, the high-availability component may provide outwards the collected server status information, service status information on the server, and configuration file information in the cluster, and an alarm platform may subsequently be connected. Operation and maintenance personnel may repair at the first time when a cluster fault is determined.

In a practical application, the embodiments of the disclosure may deploy the high-availability components on multiple storage servers. To ensure redundancy, generally, three or more storage servers are selected. These high-availability components also form a cluster, which is in an active-standby mode, and only one high-availability component provides services outwards. In combination with an exchange mechanism software (keepalived) component, a unified virtual IP is provided outwards for communication. Keepalived is a relatively mature component that determines high-availability of the cluster using the Virtual Router Redundancy Protocol. When the high-availability component that is currently providing services fails, the virtual IP will drift to a normal server, and the high-availability component on the normal server will take over the service. Such deployment manner may bring the following advantages. (1) The storage intranet is shared, making the synchronization operation faster; (2) single-point or even multi-point faults are allowed without the upper layer being aware.

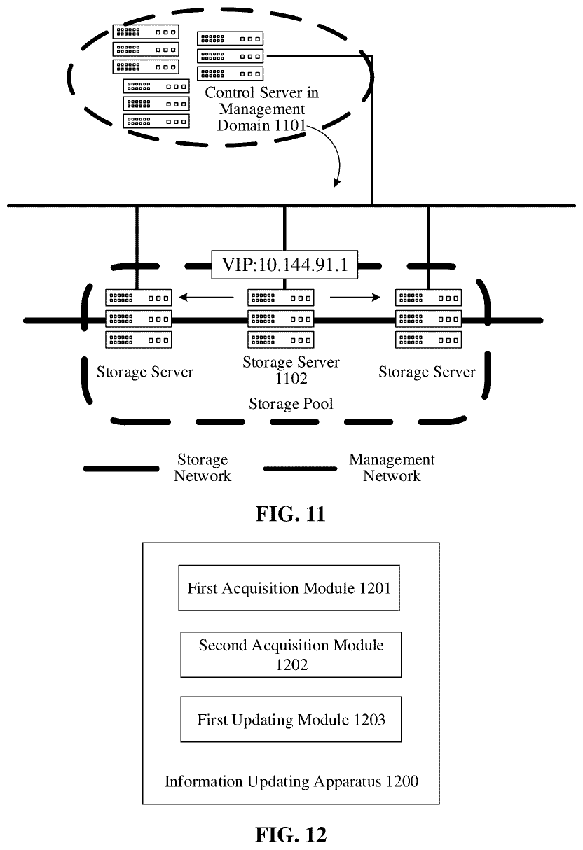

In the embodiments of the disclosure, although the high-availability component operates in an active-standby mode, the heartbeat self-adaption detection module operates in a multi-active mode. That is, any server, on which the high-availability component is deployed, regularly performs heartbeat with other servers. The advantage of such approach is that even after the active high-availability component is switched, it may immediately obtain the latest normal_list and abnormal_list. In addition, the heartbeat self-adaption module is only responsible for selecting normal and abnormal servers, and not for active-standby switching of the high-availability component. The active-standby switching of the component is determined by keepalived. The advantage of such approach is that no matter how the active-standby switching is, the exposed IP address remains unchanged, and the upper layer is unaware. Then, after detecting the configuration file, the heartbeat self-adaption detection module needs to determine whether to trigger configuration synchronization according to the result. The advantage of such approach is that, it is ensured that re-launched or expanded servers may rapidly have the latest configuration without human intervention. The improved configuration synchronization mode is shown in FIG. 11. A control server 1101 in the management domain sends a request to a storage server 1102 on which the virtual IP is located, and the request is received and forwarded by the high-availability component. Success of the request depends on whether the server, on which the high-availability component is located, is updated successfully. Redundant deployment of the high-availability component greatly improves stability of the high-availability component itself.

With the information updating method provided by the embodiments of the disclosure, firstly, the status of each storage server is detected using the heartbeat self-adaption module, and management means of self-adaption of the detection period and self-adaption of the reliability are provided, such that the results of both of normal servers and abnormal servers selected by the heartbeat module are reliable. Control operations occur on normal servers. The configuration file detection module detects differences between configuration files and takes follow-up actions on discrepancies, so as to timely and rapidly synchronizes configuration information of the cluster, such that normal servers in the cluster, including those that have recovered from faults, may have the latest configuration. The entire configuration synchronization process does not require any human intervention. The heartbeat self-adaption detection module has capabilities for both of self-adaption of the detection period and self-adaption of the reliability, which improves reliability of the detection result, and may cooperate with the configuration synchronization module to complete configuration synchronization without awareness of operation and maintenance personnel. This improves system stability and reduces maintenance costs. Secondly, modification actions made by the management control server to the configuration file are taken over by the configuration file synchronization module, and are distributed to other normal storage servers. The management server only needs to communicate with the high-availability component once, which significantly reduces communication costs. The control server needs to send one request to the high-availability component in service. The request is returned after it is completed on the server, and then forwarded by the high-availability component to all normal servers in the cluster. Efficiency of such asynchronous intranet forwarding is much higher than the communication between the control server and the storage server, which greatly improves system latency. Thirdly, the configuration file synchronization module has three working modes, i.e., partial configuration update mode triggered by the control server, entire configuration update mode triggered by the configuration file detection module, and fixed-point configuration synchronization mode triggered by human test, or operation and maintenance. Configuration synchronization needs in different cases are satisfied. Subsequently, the manner of being forwarded by the high-availability component may handle cluster single-point faults. Firstly, the component has a redundancy capability after combining with the virtual IP technology. Secondly, it regularly detects the status of storage servers, and may determine that requests from the control server are only sent to normal servers.

Based on the aforementioned embodiments, an embodiment of the disclosure provides an information updating apparatus. Each module included in the apparatus and each unit included in each module may be implemented by a processor in a computer device, and of course, may also be implemented by corresponding logic circuits. During implementation, the processor may be a CPU, a Microprocessor Unit (MPU), a DSP, an FPGA, or the like.

An embodiment of the disclosure further provides an information updating apparatus. FIG. 12 is a schematic diagram of a structure of the information updating apparatus provided by the embodiment of the disclosure. As shown in FIG. 12, the information updating apparatus 1200 includes a first acquisition module 1201, a second acquisition module 1202 and a first updating module 1203.

The first acquisition module 1201 is configured to acquire current configuration information of each server in a server cluster.

The second acquisition module 1202 is configured to acquire, when target configuration information different from reference configuration information exists, first status information corresponding to a first server which stores the target configuration information.

The first updating module 1203 is configured to update, when the first status information is a normal status, the target configuration information by using the reference configuration information.

In some embodiments, the information updating apparatus 1200 further includes a first receiving module, a parsing module and a first determination module.

The first receiving module is configured to receive a configuration command carrying the reference configuration information from a control node to obtain the reference configuration information.

The parsing module is configured to parse a current correspondence table to obtain current configuration information of each server.

The first determination module is configured to determine the first status information based on an identity of the first server, a current normal server set and a current abnormal server set.

In some embodiments, the information updating apparatus 1200 further includes a first sending module, a second determination module and a second updating module.

The first sending module is configured to consecutively send, according to a preset period, at least one heartbeat request to each server in the server cluster.

The second determination module is configured to determine, when first response information for each heartbeat request is received from a second server, that second status information of the second server is the normal status. Here, at least one first response information carries current configuration information of the second server.

The second updating module is configured to update the current correspondence table, the current normal server set and the current abnormal server set by using the at least one first response information and the second status information.

In some embodiments, the second updating module includes an acquisition submodule, a conversion submodule and an updating submodule.

The acquisition submodule is configured to acquire a current configuration file of the second server.

The conversion submodule is configured to convert the current configuration file of the second server by using a preset conversion algorithm to obtain the current configuration information of the second server.

The updating submodule is configured to update the current correspondence table, the current normal server set and the current abnormal server set by using the current configuration information of the second server and the second status information.

In some embodiments, the information updating apparatus 1200 further includes a third determination module and a third updating module.

The third determination module is configured to determine, when it is failed to receive second response information for each heartbeat request from a third server, that third status information of the third server is an abnormal status.

The third updating module is configured to update the current correspondence table, the current normal server set and the current abnormal server set by using the third status information.

In some embodiments, the information updating apparatus 1200 further includes a second receiving module, a fourth updating module, a returning module and a fifth updating module.

The second receiving module is configured to receive a configuration update command for the reference configuration information from the control node.

The fourth updating module is configured to update the reference configuration information based on the configuration update command to obtain updated reference configuration information.

The returning module is configured to return an update success result to the control node.

The fifth updating module is configured to update current configuration information of each normal server in the normal server set based on the updated reference configuration information.

In some embodiments, the information updating apparatus 1200 further includes a sixth updating module, a third acquisition module, a fourth determination module, a restarting module and a seventh updating module.

The sixth updating module is configured to update the current correspondence table based on updated target configuration information.

The third acquisition module is configured to acquire fourth status information of each service in the first server.

The fourth determination module is configured to determine, when target fourth status information being the abnormal status exists among the fourth status information, a target service corresponding to the target fourth status information.

The restarting module is configured to restart the target service to update the target fourth status information to the normal status.

The seventh updating module is configured to update the current correspondence table based on updated target fourth status information.

In some embodiments, the information updating apparatus 1200 further includes a third receiving module, a fifth determination module, a sixth determination module and an eighth updating module.

The third receiving module is configured to receive a directional update command for configuration information. Here, the directional update command carries an identity of a source server and an identity of a destination server.

The fifth determination module is configured to determine configuration information of the source server based on the identity of the source server.

The sixth determination module is configured to determine configuration information of the destination server based on the identity of the destination server.

The eighth updating module is configured to update the configuration information of the destination server using the configuration information of the source server.

It is to be noted that the description of the information updating apparatus in the embodiments of the disclosure is similar to the description of the above method embodiments, and the apparatus has similar beneficial effects to the method embodiments. For technical details not disclosed in the apparatus embodiments, please refer to the description of the method embodiments of the disclosure for understanding.

It is to be noted that in the embodiments of the disclosure, if the above information updating method is implemented in the form of a software functional module and sold or used as an independent product, it may also be stored in a computer-readable storage medium. Based on such understanding, the technical solution of the embodiments of the disclosure substantially or parts making contributions to the related art may be embodied in the form of a software product. The computer software product is stored in a storage medium, including several instructions for enabling a computer device (which may be a personal computer, a server, a network device, or the like) to perform all or part of the methods in various embodiments of the disclosure. The aforementioned storage medium includes various media capable of storing program codes, such as a USB disk, a mobile hard disk, a Read Only Memory (ROM), a magnetic disk, an optical disk, or the like. Thus, the embodiments of the disclosure are not limited to any specific combination of hardware and software.

Correspondingly, an embodiment of the disclosure provides a computer-readable storage medium having stored thereon a computer program that, when executed by a processor, implements the information updating method provided by the above embodiments.

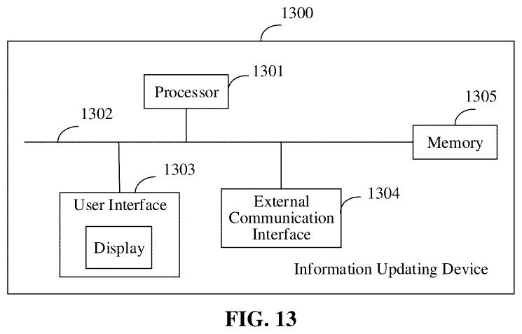

An embodiment of the disclosure provides an information updating device. FIG. 13 is a schematic diagram of a structure of the information updating device provided by the embodiment of the disclosure. As shown in FIG. 13, the information updating device 1300 includes a processor 1301, at least one communication bus 1302, a user interface 1303, at least one external communication interface 1304, and a memory 1305. Here, the communication bus 1302 is configured to implement connected communication between these components. The user interface 1303 may include a display, and the external communication interface 1304 may include standard wired and wireless interfaces. The processor 1301 is configured to execute the program of the information updating method stored in the memory to implement the information updating method provided by the above embodiments.

The above description of the embodiments of the information updating device and the storage medium is similar to the description of the above method embodiments, and the embodiments have similar beneficial effects to the method embodiments. For technical details not disclosed in the embodiments of the information updating device and the storage medium of the disclosure, please refer to the description of the method embodiments of the disclosure for understanding.

An embodiment of the disclosure provides a computer program product including computer-readable codes. When the computer-readable codes are run in an electronic device, a processor in the electronic device performs the above information updating method.

Here, it is to be noted that the above description of the embodiments of the storage medium, the information updating device and the computer program product is similar to the description of the above method embodiments, and the embodiments have similar beneficial effects to the method embodiments. For technical details not disclosed in the embodiments of the storage medium and the information updating device of the disclosure, please refer to the description of the method embodiments of the disclosure for understanding.

It is to be understood that the expression “an embodiment” or “one embodiment” throughout the specification means that a particular feature, structure, or characteristic related to the embodiment is included in at least one embodiment of the disclosure. Therefore, the expression “in an embodiment” or “in one embodiment” throughout the specification does not necessarily refer to the same embodiment. In addition, these particular features, structures or characteristics may be combined in any suitable manner in one or more embodiments. It is to be understood that in various embodiments of the disclosure, the sequence numbers of the above processes do not imply the order of execution. The order of execution of the processes should be determined by their functions and inherent logic, and should not constitute any limitation on the implementations of the embodiments of the disclosure. The sequence numbers in the above embodiments of the disclosure are only for description and do not represent superiority or inferiority of the embodiments.

It is to be noted that in the specification, the terms “include”, “contain”, or any other variant thereof, are intended to cover non-exclusive inclusion, such that a process, method, item, or apparatus that includes a series of elements not only includes those elements but also includes other elements not explicitly listed, or elements inherent to such process, method, item, or apparatus. Without more restrictions, an element limited by the expression “including a . . . ” does not exclude the presence of additional identical elements in the process, method, item, or apparatus that includes the element.

In several embodiments provided by the disclosure, it is to be understood that the disclosed devices and methods may be implemented in other manners. The device embodiments described above are only schematic. For example, division of the units is only a kind of logic function division, and there may be other division manners during a practical implementation. For example, multiple units or components may be combined or integrated into another system, or some features may be neglected or not executed. In addition, coupling or direct coupling or communication connection between various displayed or discussed components may be indirect coupling or communication connection through some interfaces, devices or units, and may be electrical, mechanical, or in other forms.

The above units illustrated as separate components may or may not be physically separated, and components displayed as units may or may not be physical units, may be located in the same place, or may also be distributed to multiple network units. Part or all of the units may be selected according to practical requirements to implement the purpose of the solution of the embodiments of the disclosure.

In addition, various functional units in various embodiments of the disclosure may be integrated into a processing unit, or each unit may be a separate unit, or two or more than two units may be integrated into a unit. The above integrated unit may be implemented in the form of hardware, or in the form of hardware and software functional units.

Those of ordinary skill in the art may understand that all or part of the operations for implementing the above method embodiments may be completed by hardware related to program instructions. The aforementioned program may be stored in a computer-readable storage medium. When executed, the program performs operations including the above method embodiments. The aforementioned storage medium includes various media capable of storing program codes, such as a mobile storage device, a ROM, a magnetic disk, an optical disk, or the like.

Alternatively, if the above integrated unit of the disclosure is implemented in the form of a software functional module and sold or used as an independent product, it may also be stored in a computer-readable storage medium. Based on such understanding, the technical solution of the embodiments of the disclosure substantially or parts making contributions to the related art may be embodied in the form of a software product. The computer software product is stored in a storage medium, including several instructions for enabling an AC to perform all or part of the methods in various embodiments of the disclosure. The aforementioned storage medium includes various media capable of storing program codes, such as a mobile storage device, a ROM, a magnetic disk, an optical disk, or the like.

The above are only implementations of the disclosure, but the scope of protection of the disclosure is not limited thereto. Any variations or replacements apparent to those skilled in the art within the technical scope disclosed by the disclosure shall fall within the scope of protection of the disclosure. Therefore, the scope of protection of the disclosure shall be subject to the scope of protection of the claims.

### INDUSTRIAL APPLICABILITY

Current configuration information of each server in a server cluster is acquired by a target server. Then, each current configuration information is compared with reference configuration information. If target configuration information different from the reference configuration information exists among the current configuration information, first status information corresponding to a first server which stores the target configuration information is acquired. Then, if the first status information corresponding to the first server is a normal status, the target configuration information is updated using the reference configuration information to complete the configuration information update. In this way, since the target server is included in the server cluster, the target server and each server in the server cluster belong to the same network resource. Therefore, when the target server communicates with each server, the network communication overhead is low. In addition, since the target server updates the configuration information for the server in the normal status, even if a server in the server cluster fails due to some reason, the configuration information update of normal servers will not be affected.

1. An information updating method, applied to a target server in a server cluster, wherein the target server stores reference configuration information, and the method comprises:
acquiring current configuration information of each server in the server cluster;
acquiring, when there exists target configuration information which is different from the reference configuration information, first status information corresponding to a first server which stores the target configuration information; and
updating, when the first status information represents a normal status, the target configuration information by using the reference configuration information.

2. The method of claim 1, wherein the target server further stores a current correspondence table, a current normal server set and a current abnormal server set; the current correspondence table comprises at least an identity of each server, status information of each server, and current configuration information of each server; and the method further comprises:
receiving a configuration command carrying the reference configuration information from a control node to obtain the reference configuration information;
parsing the current correspondence table to obtain the current configuration information of each server; and
determining the first status information based on an identity of the first server, the current normal server set and the current abnormal server set.

3. The method of claim 2, further comprising:
for each server in the server cluster, consecutively sending, according to a preset period, at least one heartbeat request to the server;
determining, when first response information for each heartbeat request is received from a second server, that second status information of the second server represents the normal status, wherein at least one first response information carries current configuration information of the second server; and
updating the current correspondence table, the current normal server set and the current abnormal server set by using the at least one first response information and the second status information.

4. The method of claim 3, wherein updating the current correspondence table, the current normal server set and the current abnormal server set by using the at least one first response information and the second status information comprises:
acquiring a current configuration file of the second server;
converting the current configuration file of the second server by using a preset conversion algorithm to obtain the current configuration information of the second server; and
updating the current correspondence table, the current normal server set and the current abnormal server set by using the current configuration information of the second server and the second status information.

5. The method of claim 3, further comprising:
determining, when it is failed to receive second response information for each heartbeat request from a third server, that third status information of the third server represents an abnormal status; and
updating the current correspondence table, the current normal server set and the current abnormal server set by using the third status information.

6. The method of claim 2, further comprising:
receiving a configuration update command for the reference configuration information from the control node;
updating the reference configuration information based on the configuration update command to obtain updated reference configuration information;
returning an update success result to the control node; and
updating current configuration information of each normal server in the current normal server set based on the updated reference configuration information.

7. The method of claim 2, wherein the current correspondence table further comprises status information of services deployed on each server; and after updating the target configuration information by using the reference configuration information, the method further comprises:
updating the current correspondence table based on updated target configuration information;
acquiring fourth status information of each service in the first server;
determining, when there exists target fourth status information representing an abnormal status in respective pieces of fourth status information, a target service corresponding to the target fourth status information;
restarting the target service to update the target fourth status information to the normal status; and
updating the current correspondence table based on updated target fourth status information.

8. An information updating apparatus, applied to a target server in a server cluster, wherein the target server stores reference configuration information, and the information updating apparatus comprises:
a processor; and
a memory, configured to store a computer program executable on the processor;
wherein the processor is configured to execute the computer program to:
acquire current configuration information of each server in the server cluster;
acquire, when there exists target configuration information which is different from the reference configuration information, first status information corresponding to a first server which stores the target configuration information; and
update, when the first status information represents a normal status, the target configuration information by using the reference configuration information.

9. The information updating apparatus of claim 8, wherein the target server further stores a current correspondence table, a current normal server set and a current abnormal server set; the current correspondence table comprises at least an identity of each server, status information of each server, and current configuration information of each server; and the processor is further configured to execute the computer program to:
receive, from a control node, a configuration command carrying the reference configuration information to obtain the reference configuration information;
parse the current correspondence table to obtain the current configuration information of each server; and
determine the first status information based on an identity of the first server, the current normal server set and the current abnormal server set.

10. The information updating apparatus of claim 9, wherein the processor is further configured to execute the computer program to:
for each server in the server cluster consecutively send, according to a preset period, at least one heartbeat request to the server;
determine, when first response information for each heartbeat request is received from a second server, that second status information of the second server represents the normal status, wherein at least one first response information carries current configuration information of the second server; and
update the current correspondence table, the current normal server set and the current abnormal server set by using the at least one first response information and the second status information.

11. The information updating apparatus of claim 10, wherein the processor is further configured to execute the computer program to:
acquire a current configuration file of the second server;
convert the current configuration file of the second server by using a preset conversion algorithm to obtain the current configuration information of the second server; and
update the current correspondence table, the current normal server set and the current abnormal server set by using the current configuration information of the second server and the second status information.

12. The information updating apparatus of claim 10, wherein the processor is further configured to execute the computer program to:
determine, when it is failed to receive second response information for each heartbeat request from a third server, that third status information of the third server represents an abnormal status; and
update the current correspondence table, the current normal server set and the current abnormal server set by using the third status information.

13. The information updating apparatus of claim 9, wherein the processor is further configured to execute the computer program to:
receive a configuration update command for the reference configuration information from the control node;
update the reference configuration information based on the configuration update command to obtain updated reference configuration information;
return an update success result to the control node; and
update current configuration information of each normal server in the current normal server set based on the updated reference configuration information.

14. The information updating apparatus of claim 9, wherein the processor is further configured to execute the computer program to:
update the current correspondence table based on updated target configuration information;
acquire fourth status information of each service in the first server;
determine, when there exists target fourth status information representing an abnormal status in respective pieces of fourth status information, a target service corresponding to the target fourth status information;
restart the target service to update the target fourth status information to the normal status; and
update the current correspondence table based on updated target fourth status information.

15. (canceled)

16. A non-transitory computer-readable storage medium having stored thereon computer-executable instructions that when executed by a processor of a target server, execute operations of:
acquiring current configuration information of each server in a server cluster;
acquiring, when there exists target configuration information which is different from reference configuration information, first status information corresponding to a first server which stores the target configuration information; and
updating, when the first status information represents a normal status, the target configuration information by using the reference configuration information.

17. (canceled)

18. The non-transitory computer-readable storage medium of claim 16, wherein the target server further stores a current correspondence table, a current normal server set and a current abnormal server set; the current correspondence table comprises at least an identity of each server, status information of each server, and current configuration information of each server; and the operations further comprise:
receiving a configuration command carrying the reference configuration information from a control node to obtain the reference configuration information;
parsing the current correspondence table to obtain the current configuration information of each server; and
determining the first status information based on an identity of the first server, the current normal server set and the current abnormal server set.

19. The non-transitory computer-readable storage medium of claim 18, wherein the operations further comprise:
for each server in the server cluster, consecutively sending, according to a preset period, at least one heartbeat request to the server;
determining, when first response information for each heartbeat request is received from a second server, that second status information of the second server represents the normal status, wherein at least one first response information carries current configuration information of the second server; and
updating the current correspondence table, the current normal server set and the current abnormal server set by using the at least one first response information and the second status information.

20. The non-transitory computer-readable storage medium of claim 19, wherein updating the current correspondence table, the current normal server set and the current abnormal server set by using the at least one first response information and the second status information comprises:
acquiring a current configuration file of the second server;
converting the current configuration file of the second server by using a preset conversion algorithm to obtain the current configuration information of the second server; and
updating the current correspondence table, the current normal server set and the current abnormal server set by using the current configuration information of the second server and the second status information.

21. The non-transitory computer-readable storage medium of claim 19, wherein the operations further comprise:
determining, when it is failed to receive second response information for each heartbeat request from a third server, that third status information of the third server represents an abnormal status; and
updating the current correspondence table, the current normal server set and the current abnormal server set by using the third status information.

22. The non-transitory computer-readable storage medium of claim 18, wherein the operations further comprise:
receiving a configuration update command for the reference configuration information from the control node;
updating the reference configuration information based on the configuration update command to obtain updated reference configuration information;
returning an update success result to the control node; and
updating current configuration information of each normal server in the current normal server set based on the updated reference configuration information.
